(19) United States
(12) Patent Application Publication
(10) Pub. No.: US 2008/0209223 A1
(43) Pub. Date: Aug. 28, 2008

(54) TRANSACTIONAL VISUAL CHALLENGE IMAGE FOR USER VERIFICATION

(75) Inventors: Palash Nandy, San Francisco, CA (US); Daniel E. Walling, Mountain View, CA (US)

Correspondence Address: SCHWEGMAN, LUNDBERG & WOESSNER/EBAY, P.O. BOX 2938, MINNEAPOLIS, MN, 55402, US

(73) Assignee: EBAY INC., SAN JOSE, CA (US)

(21) Appl. No.: 11/679,527

(22) Filed: Feb. 27, 2007

(51) Int. Cl. H04L 9/32

(52) U.S. Cl. 713/185

(57) ABSTRACT

A method and a system generate a transactional visual challenge image to be presented to a user thereby to verify that the user is human. For example, an image module generates a visual challenge to be presented to a user as part of a challenge-response to verify that the user is human. A transactional background image module identifies a transactional background that is associated with a specific transaction and a combiner image module combines the visual challenge and the transactional background into an image which is to be presented to the user during transaction authorization, the transactional background associating the visual challenge with the particular transaction.

### TECHNICAL FIELD

The present application relates generally to the technical field of access security within a computer environment and, in one specific example, to the generation of a transactional visual challenge image to be presented as part of a challenge-response to verify that a user is human as part of a transaction authorization.

### BACKGROUND

A problem that often arises in an Internet environment is that of unauthorized or improper access to websites by robots, commonly referred to as “bots”. Bots are programs that are run on computers that automatically access a website without the need for human or user interaction. Although some bots may access a website for proper purposes, e.g., search engine spiders that are authorized to scrape information from web pages, other bots perform improper functions. For example, certain bots access websites and register multiple fictitious users for improper purposes, access websites to mine confidential user information, guess user passwords, list items without authorization on sale or auction websites, and so on. It will be appreciated that, due to the high processing power of computers running bots, a large number of unauthorized accesses may take place in an extremely short period of time. However, although unauthorized access by a user or human may still occur, it is a substantially slower process.

In order to avoid access by bots, websites may present an image-based test or CAPTCHA (Completely Automated Public Turing test to tell Computers and Humans Apart) to a user wherein the user is required to identify glyphs, (e.g., characters, numerals and/or symbols) in the image. The user is then requested to enter the glyphs manually and a comparison is then performed to check if the manually entered glyphs match those provided in the image presented to the user (e.g., the characters and numbers match the characters and numbers entered by the user). It will be appreciated that the image presented to the user should be arranged in such a fashion so as to inhibit recognition thereof by a robot (aka, a bot).

A frequently noted method to bypass this automation prohibition is to circumvent this image-based test to tell computers and humans apart. In such a method the test is simply moved outside the specific environment running the automation sequence to a manual process. This method is simplified by the relative ease of moving an image outside of the context and specific environment for which its authors/creators intended.

For example, a party intent on committing fraud and utilizing information obtained through an automated process protected by an image based test may lift that test onto their own interface and use external labor (e.g., human operators employed by them) to solve the tests for them. Recombined with the answers to these tests the automated process could continue past the testing point unabated. As the typical implementation and environment of an image-based test are often unidentifiable, the external laborer would not necessarily comprehend that they are aiding in illicit activity.

Another alternative is a website approach where unsuspecting users are given an image-based test in order to receive a perceived benefit or service. For example, where a user is requested to enter sweepstakes to win a prize or to proceed to a next group of pictures by simply answering a visual challenge presented by the image based test, where the image-based test was actually lifted from another completely unrelated website as part of a traditional test.

Apart from the verification of access to a particular website, program or application, a need has been identified to verify that a user is human during the authorization of a particular transaction. For example, certain attacks may be reliant on the deployment of malicious code that, instead of moving the imaged-based test to gain access to a website, waits for the user to legitimately log into a website. Once the user is logged into the website, the malicious code may create a transaction, e.g., transfer money from an account, while the user is accessing certain information on the website or conducting a separate transaction.

### BRIEF DESCRIPTION OF THE DRAWINGS

Some embodiments are illustrated by way of example and not limitation in the figures of the accompanying drawings in which:

FIG. 1 is a schematic block diagram of system in accordance with an example embodiment;

FIG. 2 is a high-level entity-relationship diagram illustrating tables that may be maintained within a challenge data database, in accordance with an example embodiment;

FIG. 3 is a high-level entity-relationship diagram illustrating tables that may be maintained within a transactional background database, in accordance with an example embodiment;

FIG. 4 is a schematic flow diagram of a method, in accordance with an example embodiment, to generate a transactional visual challenge image;

FIG. 5 is a detailed schematic flow diagram of a method, in accordance with an example embodiment, to generate a visual challenge to be presented as part of a challenge-response to verify that a user is human;

FIG. 6 is a detailed schematic flow diagram of a method, in accordance with an example embodiment, of identifying a transactional background that is contextual to a specific transaction;

FIG. 7 is a detailed schematic flow diagram of a method, in accordance with an example embodiment, to combine a visual challenge and a transactional background to generate the transactional visual challenge;

FIG. 8, is a detailed schematic flow diagram of a method, in accordance with an example embodiment, to combine a transactional visual challenge image with shared secret data, to present to a user during authorization of a particular transaction;

FIG. 9 shows a schematic flow diagram of a method, in accordance with an example embodiment, to generate reference data including a reference sequence;

FIG. 10 shows a schematic flow diagram of a method, also in accordance with an example embodiment of the invention, to monitor user interaction with a computer;

FIG. 11 shows a schematic representation of an example user interface presented to the user on the computer;

FIG. 12 shows an example user interface for a visually impaired user;

FIG. 13 shows an example table for monitoring repetitive use of a token;

FIGS. 14 and 15 show example embodiments of visual challenges generated using the methods of FIGS. 4 and 5;

FIGS. 16 to 19 show example embodiments of images generated using the methods of FIGS. 4 to 7;

FIG. 20 shows an example embodiment of an image generated using the methods of FIGS. 4 to 8;

FIG. 21 shows a representation of a grid card to be used by a user of the system of FIG. 1 when solving a visual challenge, in accordance with an example embodiment; and

FIG. 22 shows schematic hardware architecture of an example computer for executing any one of the methods described herein.

### DETAILED DESCRIPTION

Example methods and systems to generate a transactional visual challenge image to be presented to a user to verify that the user is human are described. In the following description, for purposes of explanation, numerous specific details are set forth in order to provide a thorough understanding of example embodiments. It will be evident, however, to one skilled in the art that the present invention may be practiced without these specific details.

In one example embodiment an image, e.g. a transactional visual challenge image, is provided to a user as part of an image-based test or CAPTCHA (Completely Automated Public Turing test to tell Computers and Humans Apart) to verify that the user is human. The image is generated by combining two graphics or images in the example forms of a visual challenge and a transactional background. The visual challenge includes a reference sequence in the form a multiple distorted and modified glyphs which the user has to identify and enter into a data field to complete the image-based test or CAPTCHA test. The transactional background is contextual to a specific transaction and associates the visual challenge with the specific transaction. In an example embodiment, the transactional background comprises a transaction identifier, which is associated with a particular transaction from the perspective of a transaction server or processor. For example, the transaction server or processor may identify a recipient detail and include the recipient detail in the transaction background. This may provide the user with confirmation that the user is authenticating a valid transaction during the image-based test.

Accordingly, the transactional background of the image allows a user to associate the visual challenge with the specific transaction. In circumstances where a party, intent on committing fraud, intervenes in a transaction and presents the test to the authorized user of the computer, the authorized user will be aware that the transaction he or she is entering in is a fraudulent transaction, as the transactional background may indicate that the recipient is unknown to the user, or that the billing or delivery address is incorrect. The unsuspecting user may in these circumstances abort the transaction and alert service providers associated with the specific transaction.

In another example embodiment, the abovementioned image, e.g. a transactional visual challenge image, may be presented to the user as part of incrementally revealed portions of shared secret data. For example, the shared secret data may be a particular secret visual image such as a photograph which is only shared between the transaction provider and the user. The transaction provider may provide only a portion of the secret visual image or photograph that overlaps with the transactional visual challenge image in color (e.g., the revealed portion), while the remaining portion of the secret visual image is in black and white. In these circumstances, the remaining portion of the secret visual image would not be reproducible by the computer in color, although the portions would be human verifiable. The changing secret visual image may also make it more difficult for malicious code such as a Trojan to generate fake transactional visual challenge images.

In yet another example embodiment, a grid card may be provided to a user to enable the user to provide the result of the transactional visual challenge image as an associated code corresponding to the key provided by the grid card. This assures a transaction provider operating a transaction application that the user entering the code is in fact the holder of the grid card, decreasing the risk of fraudulent transactions.

### Architecture

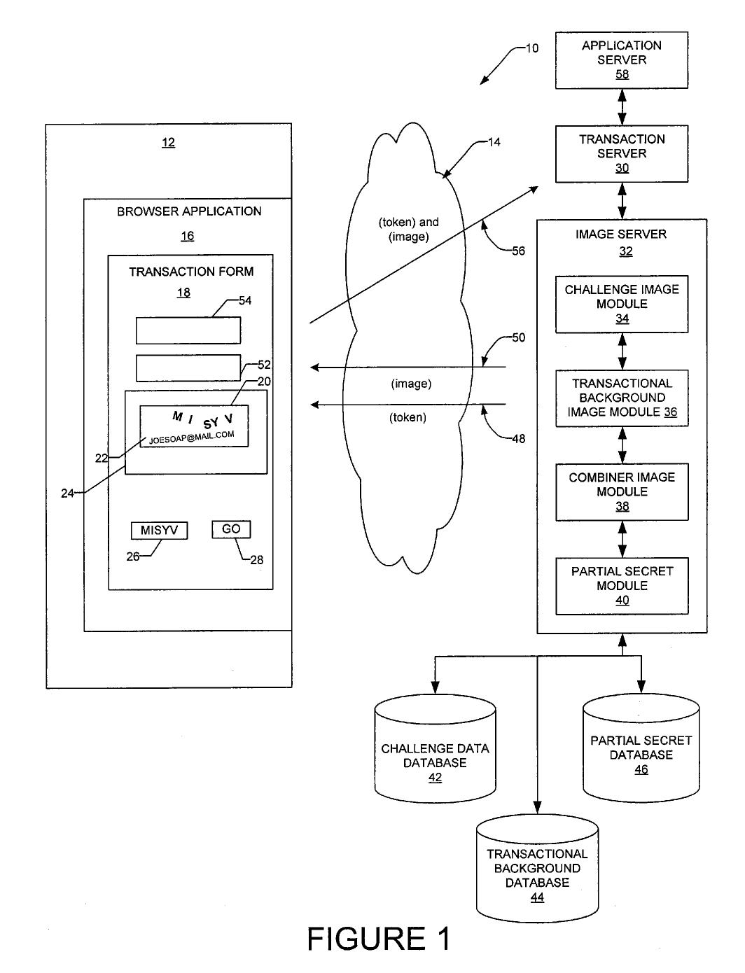

Referring in particular to FIG. 1, reference numeral 10 generally indicates a system, in accordance with an example embodiment, to generate an image, e.g., transactional visual challenge image, to be presented to a user to verify that the user of a computer 12 is human and to further verify that a particular transaction is authorized. In one example embodiment, the system 10 is used in an Internet environment where a user accesses a website of an Internet service facility, registers or logs in to the website and commences a transaction. Accordingly, in one example embodiment the description relates to a transaction authorization process via the Internet 14. However, it would be appreciated that the system 10 may find relevance in any computer environment in which user interaction in a particular transactional environment on the computer 12 is to be verified. Some examples of other computer environments where the system may find relevance are portal environments or application environments. An example of an application environment is an on-line application environment provided by an application of a provider, which may be similar to the example of FIG. 1.

The computer 12 includes a web browser application 16, which generates a user interface, such as an example transaction form 18. The transaction form 18 includes a predefined image area 20 for displaying the transactional visual challenge image 22. The predefined image area 20 is where the image 22 to be presented to the user is displayed. In an example embodiment, the predefined image area 20 may further be located over a secret visual image forming a further background to the transactional visual challenge image. In order to effect a transaction, a user is required to read the random transactional visual challenge image 22 from the image area 20 and over the secret visual image 24 and enter a sequence identified into a user data input field 26. In one example embodiment, the sequence identified by the user may first need to be converted to an associated code through the use of a grid card in the possession of the user.

In order to complete a transaction, the user activates a “GO” button 28 which then communicates the transactional information to a transaction processor or server 30. In one example embodiment, the transaction form 18 may be a confirmation form that displays certain selections made by a user. The user may, in these circumstances, confirm the transaction by completing the transactional visual challenge.

As described in more detail below, the image 22 is generated by combining a visual challenge and a background image that is contextual to a specific transaction. The visual challenge is generated by distorting and modifying a plurality of randomly selected glyphs, forming a reference sequence, by randomizing spacing, placement, font type, font size, glyph orientation or vertical offset of the glyphs. These distortions and modifications may be used to inhibit the acquisition of the visual challenge by an automated process, such as a software robot using optical character recognition (OCR). This visual challenge is used, as part of a challenge-response, to determine that a user is human and not a robot.

The transactional visual challenge image 22 is sufficiently clear so that the user may read the visual challenge, in combination with the transactional background, identify the transactional background as a background contextual to a particular transaction, and then to enter the corresponding glyphs of the reference sequence of the visual challenge into the user data input field 26. Thus, in order to effect transaction authorization, human interaction with the computer 12 is required.

Also described in more detail below is the combination of the transaction visual challenge image 22 in the image area 20 with the secret visual image.

In one example embodiment, the transactional visual challenge image 22 is generated by an image server 32. The image server 32 may further combine the transaction visual challenge image 22 with shared secret data, e.g., the secret visual image 24. As shown in FIG. 1, the image server 32 may comprise a challenge image module 34, a transactional background image module 36, a combiner image module 38 and a partial secret module 40. These modules themselves are communicatively coupled (e.g., via appropriate interfaces) to each other and to various data sources, (e.g. a challenge data database 42, a transactional background database 44 and a shared secret data database 46) so as to allow information to be passed between the modules or so as to allow the applications to share and access common data.

The challenge image module 34 is to generate the visual challenge which is to be presented to a user as part of a challenge-response. This challenge-response is used to verify that the user is human and not a robot using OCR to gain access to the website. The visual challenge may be an image-based test to which a response is provided by the user. An example of an image-based test is a CAPTCHA test, wherein the visual challenge may be a sequence of glyphs (e.g. characters, numbers and/or symbols). It will be appreciated that other image-based tests may be employed, such as a visual pattern recognition problem (e.g. requesting a response to find a correlation between symbols in two different figures) or a test in which several different images that mostly include the same subject are distorted, displayed and a user is prompted to identify the subject.

The example embodiments described below all relate to visual challenges that include a reference sequence of modified glyphs, but the present application is not limited to such a visual challenge and may employ the visual challenges mentioned above, or combinations thereof.

In one example embodiment, the challenge image module 34 is to generate a glyph-based visual challenge by randomly selecting a number of glyphs. The randomly selected glyphs are the basis of the visual challenge and form a reference sequence to be checked against the response of the user. The challenge image module 34 randomizes at least one of a spacing, placement, font type, font size, glyph orientation or vertical offset of each of the glyphs of the reference sequence, thereby to form a distorted and modified reference sequence in the form of a visual challenge.

The transactional background image module 36 is to identify a transactional background that is contextual to a specific transaction. As mentioned, the specific transactional environment may be any one of a group of transactional environments including a website environment, a portal environment or an application environment. In an example embodiment, each environment provides a user with various transaction options, with each transaction entered into by a user being identifiable through transaction identifiers associated with the transaction. The transaction may be either a financial transaction or may relate to an agreement or a contract between parties. For example, the financial transaction may relate to a purchase transaction, a barter transaction, a transfer of money (e.g., currency or a proprietary currency) from a bank or monetary account.

In one example embodiment, the transactional background (through the transaction identifier) is associated with the particular transaction from the perspective of the transaction server or processor 30. For example, the transaction server 30 may identify a recipient or recipient details of the transaction.

A transaction identifier may be at least one of a group of identifiers including an identifier of or associated with a payment recipient, a transaction amount, a shipping address or a portion of a contract or agreement. The identifier of or associated with the payment recipient may be an e-mail address, an account identifier or a personal identification number of a recipient of the transaction. The image server 32 may present the transactional background as a watermark to the visual challenge.

In one example embodiment, the transactional background image module 36 is to select a transaction identifier from the transactional background database 44. In another example embodiment, the transactional background image module 36 may comprise logic to intelligently identify the most relevant details of a transaction from transactional details entered by the user, from the perspective of the transaction server 30. For example, the transactional background image module 36 may identify the name or e-mail address of the recipient of a transaction. Also, the transactional background image module 36 may identify the clause in a contract or agreement that lists the parties to the contract as the most relevant information and select that portion as the transaction identifier.

The transactional background image module 36 may further be configured to select a number of times the transaction identifier is to be presented in the transactional background on the predefined image area 20. The transactional background image module 36 may also select a random size for a presentation of the transaction identifier, select a random location for the presentation of the transaction identifier, select a random orientation for the presentation of the transaction identifier and distribute the presentation of the transaction identifier in the predefined image area 20. It will be appreciated that, depending on the application, all of the above functions may be performed by the transactional background image module 36, or that only a selection of the functions may be performed to generate the transactional background.

In certain embodiments, the transactional background image module 36 may determine the location of the visual challenge in the predefined image area 20 prior to selecting a random location for the presentation of the transaction identifier. This may be done in applications where the presentation of the transaction identifier is not to be obscured by the visual challenge.

The combiner image module 38 is to combine the visual challenge and the transactional background into a transactional visual challenge image which is to be presented to the user in the specific environment. The transactional background associates the visual challenge with the specific transaction. The combiner image module 38 may first retrieve a visual challenge from the challenge image module 34 and a transactional background from the transactional background image module 36.

In some example embodiments, the combiner image module 38 may also be used to select a color or color arrangement for the visual challenge and for the transactional background. This feature may be advantageous to identify a color combination that would make it even more difficult for a bot to distinguish between the transactional background and the visual challenge.

The partial secret module 40 may be configured to select shared secret data from the shared secret data database 46, of which a portion would be only partially revealed every time a transactional visual challenge image is generated and displayed to a user. For example, the partial secret module 40 may select from the shared secret data database 46 in order for the combiner image module 38 to overlay the transaction visual challenge image with a partially revealed portion of the secret visual image 24, where the secret visual image is, e.g., a photograph.

In an example embodiment, the partial secret module 40 would select an area of the secret visual image 24 to overlay with the transactional visual challenge image 22. The partial secret module 40 may be configured to fully reveal this portion of the secret visual image 24, by displaying this portion in color (e.g., the revealed portion). In addition, the partial secret module 40 may be configured to only partially reveal the remaining portion of the secret visual image 24 by displaying this portion only in black and white. The remaining (or black and white) portion of the secret visual image 24 would not be reproducible in color by a bot, although the different colored portions would be human verifiable as forming part of the same image.

The combiner image module 38 is to combine the transactional visual challenge image with the secret visual image 24 ensuring that the revealed portion of the image overlays only the image area 22. When executing a transaction, the user may be prompted to ensure that this feature forms part of the overall visual challenge.

In an example embodiment, the process of generating a transactional visual challenge image is initiated when the web browser application 16 requests a transaction form from an application server 58. The application server 58, transaction server 30 and image server 32 are communicatively coupled (e.g., via appropriate interfaces) to each other. Once the transaction form is requested, the application server 58 corresponds with the image server 32 to request the generation of a reference sequence.

After the reference sequence is generated by the challenge image module 34 of the image server 32, it is passed, e.g., in the form of a token, via the Internet 14 to the browser application 16 as shown by arrow 48. After the combiner image module 38 has generated the image 22, the image server 32 communicates it, as shown by arrow 50, to the browser application 16 for inclusion in the predefined image area 20. After the user has entered the characters, numbers and/or symbols to identify the visual challenge into the user data input field 26, and completed other details in the transaction form, e.g. completed details in fields 52, 54, the token and the user input data in the user data input field 26 are then communicated to the transaction server 30, as shown by arrow 56. The transaction server 30 then decrypts the token to obtain the reference sequence, and then compares the sequence entered by the user with the reference sequence and, if the sequences match, the transaction server 30 may authenticate the user. In an example embodiment where a grid card is used by a user to provide the result of the transactional visual challenge image as a code corresponding to the key provided by the grid card, the transaction server 30 will check the sequence entered by the user with a converted reference sequence.

In addition to comparing the two sequences, the transaction server 30 also performs a checksum validation and time stamp analysis of the token, as described in more detail below.

### Data Structures

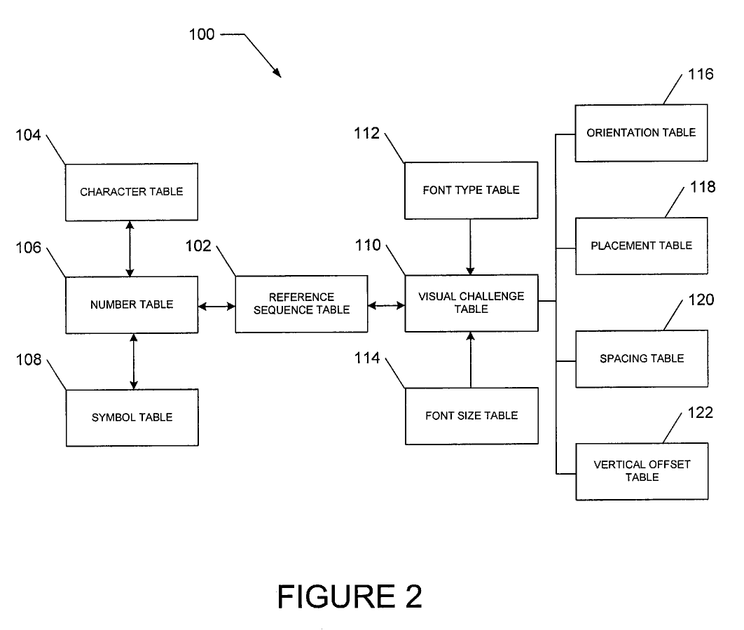

FIG. 2 is a high-level entity-relationship diagram, illustrating various tables 100 that may be maintained within the challenge data database 42, and that are utilized by and support the challenge image module 34. A reference sequence table 102 contains a record of reference sequences generated by the challenge image module 34, and may include time/stamp information pertaining to each reference sequence.

The tables 100 also include a character table 104 in which are maintained all characters that may be selected to generate a visual challenge. Likewise, a number table 106 and symbol table 108 maintain respectively all numbers and symbols that may be selected to generate a visual challenge. It will be appreciated that the items in the character table 104, number table 106 and symbol table 108 may be maintained not to include characters, numbers or symbols that may be too difficult to recognize by a human once distorted or modified. For example, punctuation marks such as “.” or “,” may be excluded from the symbol table 108.

Multiple glyphs, e.g. characters, numbers and/or symbols are selected from the character table 104, number table 106 and symbol table 108 randomly, to form the reference sequence stored in the reference sequence table 102.

A visual challenge table 110 contains a record of visual challenges generated by the challenge image module 34, e.g., the reference sequences after they have been distorted and modified and may also include time/stamp information pertaining to each reference sequence. A font type table 112 contains records of the different font types that may be used to randomly modify each glyph in a reference sequence to form a visual challenge. In one embodiment, the font sets are handmade by humans and stored in a font library for retrieval each time a font is requested. Each font set may comprise a plurality of font images as described in more detail below. Similarly, a font size table 114 contains the allowable font sizes that may be used to size each glyph that forms part of the reference sequence. Other tables, such as an orientation table 116, placement table 118, spacing table 120 and vertical offset table 122 respectively contain information on the parameters to randomly select the orientation of a glyph in a visual challenge, the placement of each glyph, the spacing between glyphs and the vertical offset of each glyph within the visual challenge.

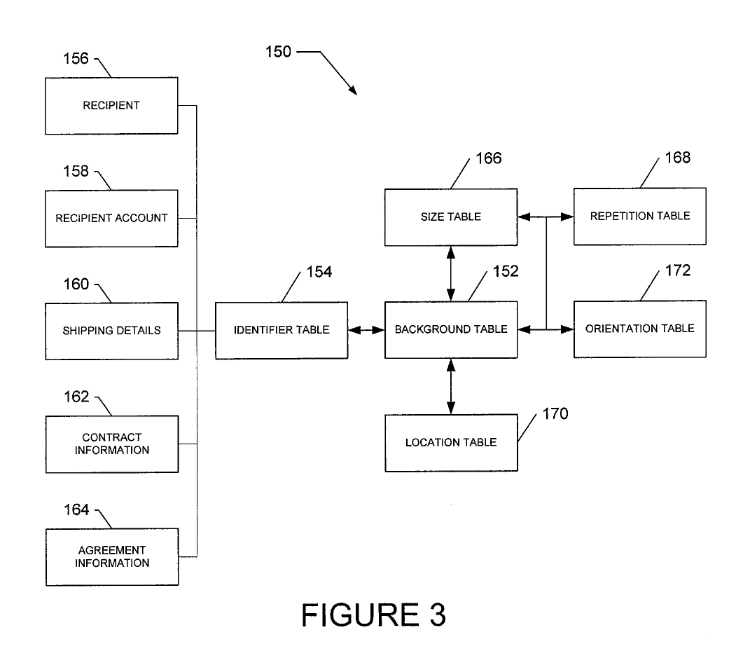

FIG. 3 is a high-level entity-relationship diagram, illustrating various tables 150 that may be maintained within the transactional background database 44, and that may be utilized by and support the transactional background image module 36. A background table 152 may contain a record of transactional backgrounds generated by the transactional background image module 36. These records may include certain time/stamp information pertaining to the generation and/or use of each of the transactional backgrounds.

An identifier table 154 maintains information on the following identifier data groups: recipient identifiers (table 156), recipient account identifiers (table 158), recipient shipping details (table 160), contract information (table 162) and agreement information (table 164).

Similar to the tables 100 that may be maintained within the challenge data databases 42, the tables 150 may also include a size table 166 to maintain information on the allowable sizes for the transactional identifiers, a location table 170 to maintain information on the possible placements of the transaction identifiers within the predefined image area 20 and an orientation table 172 to maintain information on the orientation of the transaction identifiers in the transactional background. A repetition table 168 provides information on the number of times a particular transactional identifier may be displayed. As the number of presentations may be closely related to the selected size of an identifier, the size table 166 and repetition table 168 may be linked.

### Flowcharts

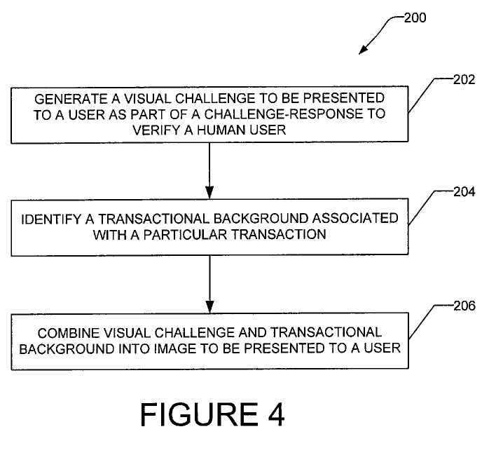

In a method of generating a transactional visual challenge image, reference numeral 200 shown in FIG. 4, generally indicates an example embodiment of the method. In one embodiment, the method 200 is carried out in the image server 32.

In an example embodiment, the method 200 commences when the web browser application 16 requests a transactional visual challenge image from the image server 32. The challenge image module 34 generates, as shown in operation 202, a visual challenge to be presented to a user as part of a challenge-response, thereby to verify that the user of the computer 12 is human. This operation may be executed during a particular transaction authorization process. In operation 204 the transactional background image module 36 identifies a transactional background that is associated with a particular transaction. In one example embodiment, the background is associated with the transaction from the perspective of the transaction server, e.g., by identifying details relating to a recipient. The combiner image module 38 combines, in operation 206, the visual challenge and the transactional background into the transactional visual challenge image which is to be presented to the user during the specific transaction in order to authorize the transaction.

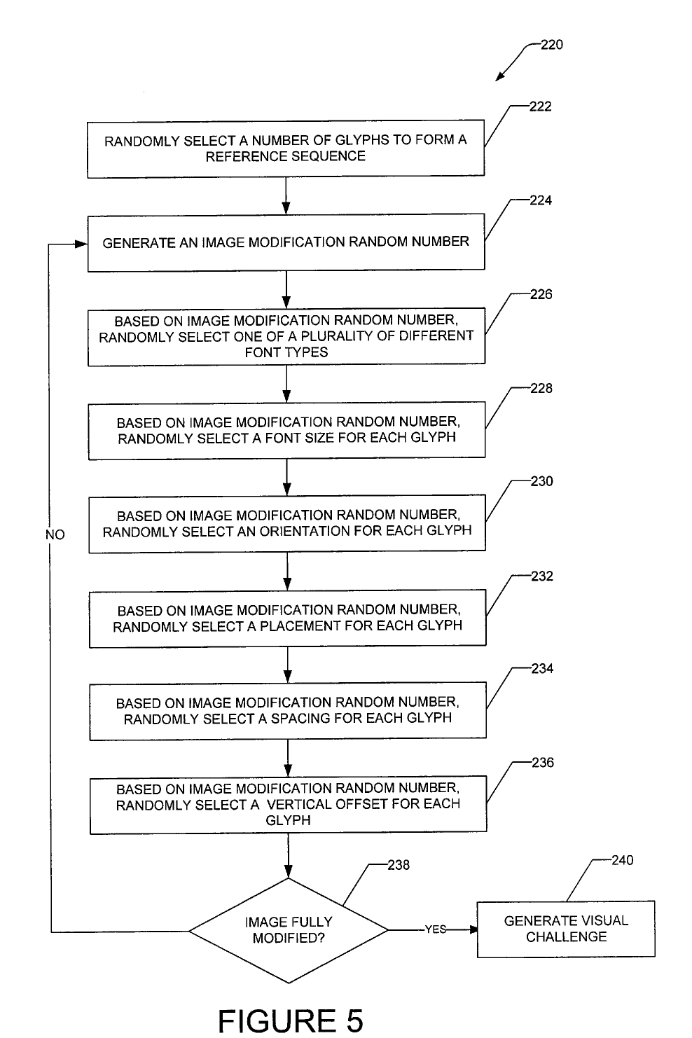

Referring in particular to FIG. 5, reference numeral 220 generally indicates a method, in accordance with an example embodiment, of generating a visual challenge to be presented as part of a challenge-response to verify that a user is human. In one example embodiment, the method is carried out in the challenge image module 34.

As shown in operation 222, a number of glyphs are randomly selected as a reference sequence. For example, the challenge image module 34 may randomly select characters, numbers and/or symbols from the character table 104, number table 106 and symbol table 108 of the challenge data database 42.

The challenge image module 34 now generates (in operation 224) an image modification random number and based on the image modification random number the visual challenge image is created by modifying the reference sequence comprising the randomly selected glyphs. For example, the image modification random number may be used randomly to select one of a plurality of different font types (see operation 226) kept in the font type table 112 of the challenge data database 42 for each glyph in the reference sequence thereby to inhibit the acquisition of the reference sequence by a robot. Similarly, the image modification random number may be used randomly to select a font size (from the font size table 114), orientation (from the orientation table 116), placement (from the placement table 118), spacing (from the spacing table 120) and vertical offset (from the vertical offset table 122), as shown in operation 228 to 236.

Once the visual challenge has been sufficiently distorted or modified (operation 238), the visual challenge is generated in operation 240 and it can be retrieved by the combiner image module 38 to be combined with an identified transactional background, as is described in more detail below.

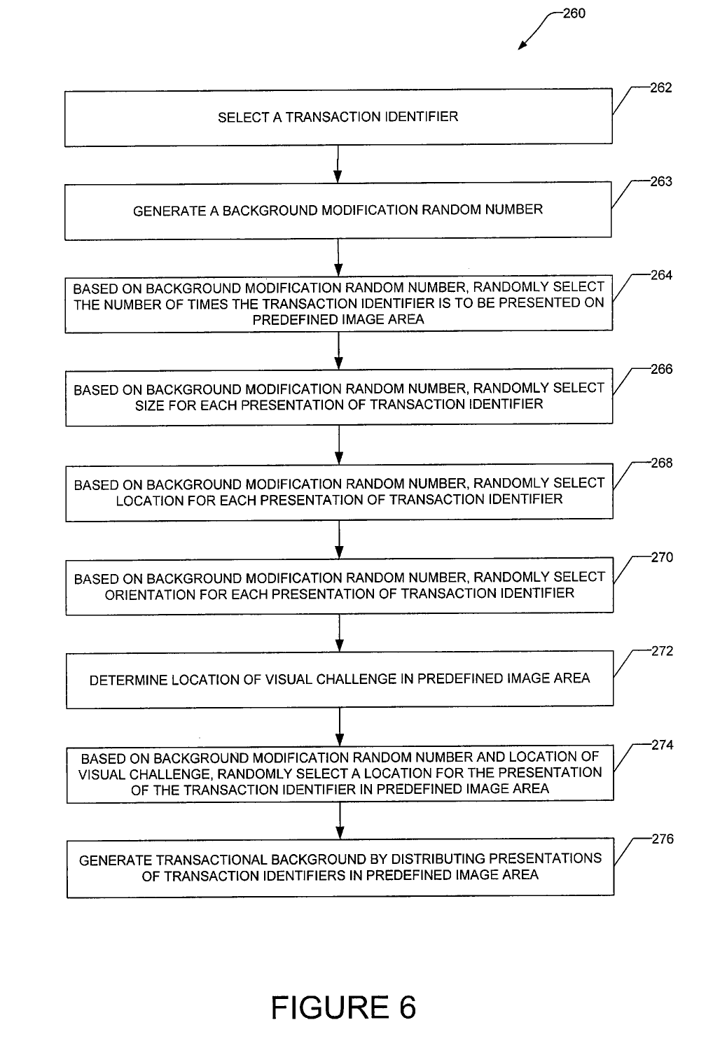

Referring in particular to FIG. 6, reference numeral 260 generally indicates a method to identify a transactional background that is contextually associated with a specific transaction, in accordance with an example embodiment. In one embodiment, the method is carried out in the transactional background image module 36.

In operation 262, a transaction identifier is selected from the identifier table 154 (in the transactional background database 44). This selection may be based on prerecorded information relating to the particular transaction or may, alternatively be in accordance with transaction data entered by the user during the completion of the transaction form 18.

In operation 263, a background modification random number is generated by the transactional background image module 36. However, it will be appreciated that in other example embodiments, the challenge image module 34 may communicate the image modification random number it generated to the transactional background image module 36 for further use. Alternatively, a separate module may generate random numbers that are to be provided to both the challenge image module 34 and the transactional background image module 36.

The transactional background image module 36 selects from the repetition table 168, and based on the background modification random number, a number of times the transaction identifier is to be presented on the predefined image area 20 (operation 264).

In operations 266 to 272 the transactional background image module 36 randomly selects, from the tables 150 of the transactional background database 44 a random size for a presentation of the transaction identifier and a random orientation for the presentation of the transaction identifier. As is shown in operation 272, the transactional background image module 36 may, prior to selecting a random location for the presentation of the transaction identifier in operation 274, determine the location of the visual challenge in the predefined image area 20. The random selection of the variables set out above may all be based on the background modification random number. However, it will be appreciated that other methods of randomly selecting the variables may be used

Having regard to all these variables, the transactional background image module 36 generates, in operation 276, the transactional background by distributing the presentation of the transaction identifier in the predefined image area 20. The transactional background may then be identified by and retrieved by the combiner image module 38 to be combined with the visual challenge.

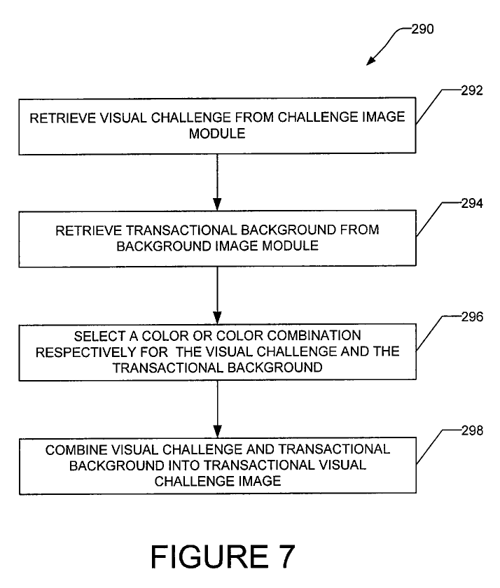

Referring in particular to FIG. 7, reference numeral 290 generally indicates a method, in accordance with an example embodiment, to combine the visual challenge and the transactional background into an image, e.g. the transactional visual challenge image, to be presented to the user during a specific transaction. In one embodiment, the method is carried out in the combiner image module 38.

In operations 292 and 294, the combiner image module 38 retrieves the visual challenge from the challenge image module 34 and also retrieves the transactional background from the transactional background image module 36. It will be appreciated that the combiner image module 38 may alternatively retrieve the visual challenge from the visual challenge table 110 of the challenge data database 42. Similarly, the combiner image module 38 may retrieve the transactional background from the background table 152 of the transactional background database 44.

The combiner image module 38 selects in operation 296 a color or color arrangement for respectively the visual challenge and for the transactional background, prior to combining the visual challenge and the transactional background (in operation 298) into an image to be presented to the user during the authorization of the specific transaction.

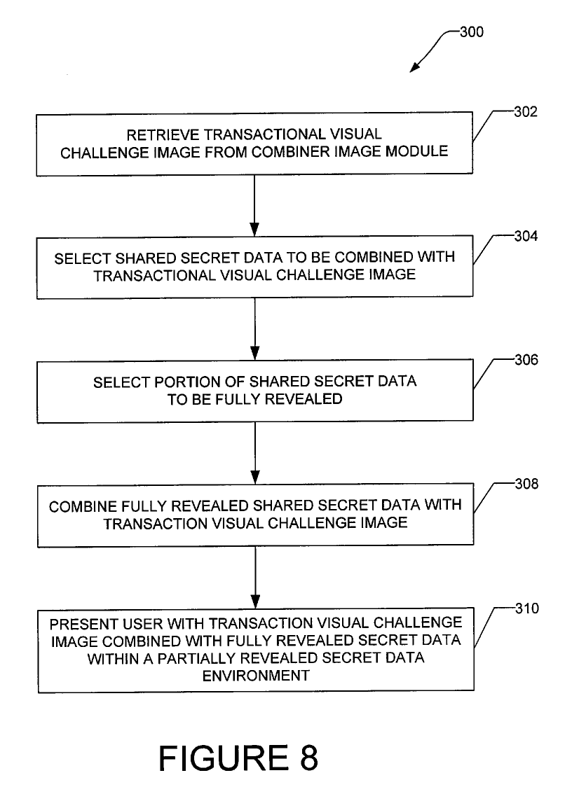

Turning to FIG. 8, reference numeral 300 generally indicates a method, in accordance with an example embodiment, to combine the transactional visual challenge image with shared secret data, to be presented to the user during authorization of a particular transaction. In one embodiment, the method is carried out by the image server 32, e.g., by the partial secret module 40 and the combiner image module 38.

As shown by operation 302, the partial secret module 40 may retrieve the transactional visual challenge image from the combiner image module 38, once the combiner image module 38 has combined the visual challenge and the transactional background. The partial secret module 40 may, as shown by operation 304, select shared secret data from the shared secret data database 46. This database may be populated by secret data that is periodically issued to the user. In one example embodiment, the shared secret data may be secret visual images that may be partially in color and partially in black and white.

In order to make the visual challenge presented to the user even more difficult for a malicious program to decipher or forge, the partial secret module 40 selects a portion of the shared secret data to be fully revealed to the user (see operation 306). For example, the partial secret module may select a portion of the secret visual image to be in color, while the remainder of the secret visual image is presented to the user in black and white.

As shown by operation 308, the partial secret module 40 now provides the image to the combiner image module 38 that combines the fully revealed shared data with the transaction visual challenge image. In the example of the secret visual image, the partial secret module 40 overlays the color portion of the secret visual image with the transaction visual challenge image, while the secret visual image surrounding the transaction visual challenge image is presented in black and white.

This is presented by operation 310 where the combiner image module 38 transmits the image to the browser application to be presented to the user with the transactional visual challenge image being combined with a portion of fully revealed secret data within a partially revealed secret data environment.

Every time the partial secret module 40 is to select a portion of the shared secret data to be fully revealed to the user, a different portion of the shared secret data will be selected. This ensures that, although a user would be able to verify the shared secret, malicious code would not be able to generate other portions (e.g., the partially revealed portions) of the shared secret.

In other example embodiments, the shared secret data may comprise video data with the transactional visual challenge image only being presented to the user during a few frames of the video. The frames during which the transactional visual challenge image are presented may, similar to the photograph example, be presented in color while the rest of the video data is presented in black and white.

The shared secret data may also relate to pixelised image, where the fully revealed portion of the shared secret is in focus, but the partially revealed image is blurred or has additional noise in order to obfuscate the full secret.

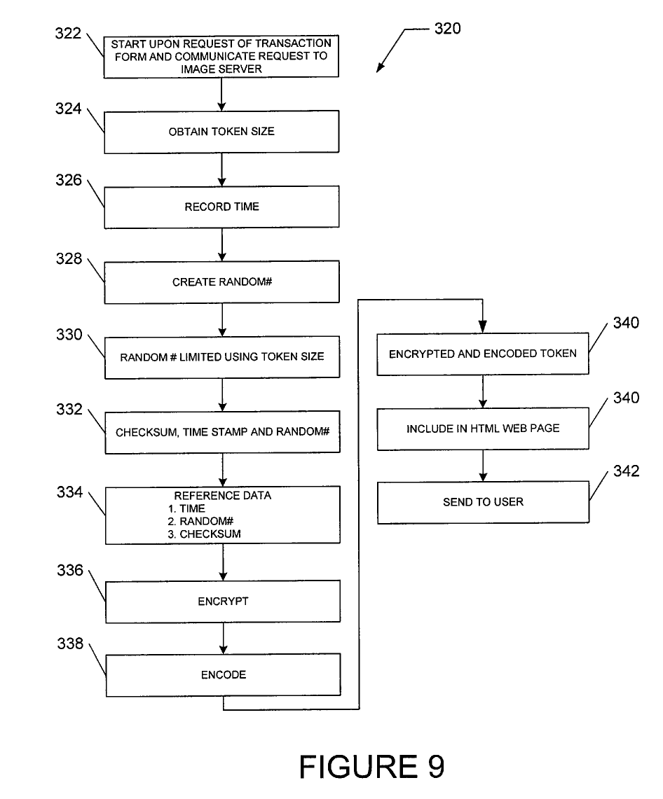

Referring to FIG. 9, reference numeral 320 generally indicates an example method for generating random reference data including a reference sequence, for use in verifying that a user is human.

As mentioned above, the browser application 16 displays the image 22 in the predefined image area 20 so that the user may identify the transactional background and visual challenge, read the visual challenge and identify the reference sequence provided therein. The user is then to manually enter the glyphs, corresponding to the reference sequence of the visual challenge, into the user data input field 26 via a keyboard of the computer 12. Once the user has completed the entire transaction form, the user typically activates the “GO” or a “SUBMIT” button 28 in response to which the browser application 16 communicates the user entered data, data entered into the form 18, and the token including the reference sequence to the transaction server 30 as shown by arrow 56 in FIG. 1. As mentioned, the visual challenge may be presented to the user as part of a confirmation transaction page, where the details of a particular transaction are to be confirmed prior to the transaction being executed.

In an example transaction process, the method 320 is initiated when the web browser application 16 requests a transaction form from the application server 58 and this request is communicated to the image server 32 (see operation 322). Thereafter, as shown at operation 324, the particular token size, to convey the reference sequence in the system 10 is determined and is time stamped in milliseconds (see operation 326). The reference sequence (as described above and as shown in operation 328) is generated by randomly selecting a number of glyphs. The random reference sequence may in certain embodiments be limited in size (see operation 330) to conform to the token size selected at operation 324. A checksum of the time stamp and the reference sequence is then performed (see operation 332) to produce reference data including time data, the reference sequence, and the checksum (see operation 334), which is then encrypted, e.g. using Blowfish, as shown in operation 336. The encrypted reference data may then be Base64 encoded (operation 338) to produce an encrypted and encoded token (see operation 340) which is then included in an HTML web page (see operation 342) and sent to the user (see arrow 48 in FIG. 1).

An example of the token including the reference data generated by the image server 32 is as follows:

| (64 bit) | (32 bit) | (32 bit) |
|---|---|---|
| 1595139460 | MISYV | 59991 |
| Time Stamp | Random Sequence | Checksum |

The time stamp of the token (see operation 326) indicates when the token was generated and, as described in more detail below, is used by the transaction server 58 to determine whether or not the token has been used before in a valid transaction process. The time stamp is typically the time on the image server 32 when the token was created.

Although in the embodiment described above, the token is communicated to the browser application 16 in an HTML web page, it is to be appreciated that it may also, in other embodiments, be passed in a cookie, in other forms, URLs, or the like. Further, the encryption of the token is typically by means of a private key and the random number is generated on-the-fly or dynamically when a request for the transaction form 18 is received from the browser application 16. Accordingly, in one embodiment, no library of numbers or images is provided, and different reference data including the random sequence, is generated each time a request from the computer 12 is processed.

When the browser application 16 performs an image call to the image server 32 to retrieve the image 22 for display in the web page, the image server 32 will use the reference sequence it has already generated stored in the challenge data database 42, and which forms part of the generated token.

Referring in particular to FIG. 9, reference numeral 350 generally indicates a method, in accordance with an example embodiment, for monitoring user interaction with the computer 12. As shown at block 352, in one embodiment the transaction server 30 receives the token including the reference data, as part of the form 18, as well as the user entered sequence. The reference data of the token is then Base64 decoded and Blowfish decrypted to obtain the reference data including the random reference sequence (see operation 354). The integrity of the reference data is then checked using the checksum (see operation 356) and, as shown at decision operation 358, if the integrity of the reference data of the token is rejected (see operation 360), the user is then given a further opportunity of a limited number of opportunities (see operation 362) to re-enter the sequence which is shown in the image 22.

However, returning to decision operation 358, if the integrity of the reference data is accepted, then the time stamp of the token is checked to ensure that it is within a particular predetermined time range or window period as shown at block 364. In particular, and depending upon the amount of detail a user is required to enter into the transaction form 18 or to confirm a transaction confirmation, a window period of about 10 seconds to 10 minutes is allowed during which the reference data of the token is valid. If the time stamp indicates a time period of less than about 10 seconds or a time period of more than about 10 minutes, it is assumed that the transaction attempt is either by a robot, or a replay attack in which multiple transaction attempts using the same token are attempted. Accordingly, as shown at decision block 366, if the time stamp of the token is not within the window period, the transaction attempt is rejected (see operation 360).

However, if the time stamp is within the acceptable window period, the user-entered sequence is compared with the reference sequence to see if they match, as shown at operation 368. If the user entered sequence and the reference sequence do not match (see operation 370) then the transaction attempt is rejected (see operation 360). In the embodiment depicted in the drawings in which the image server 32 performs the time stamping and the transaction server 30 checks the time stamping, time on the servers 30, 32 is synchronized.

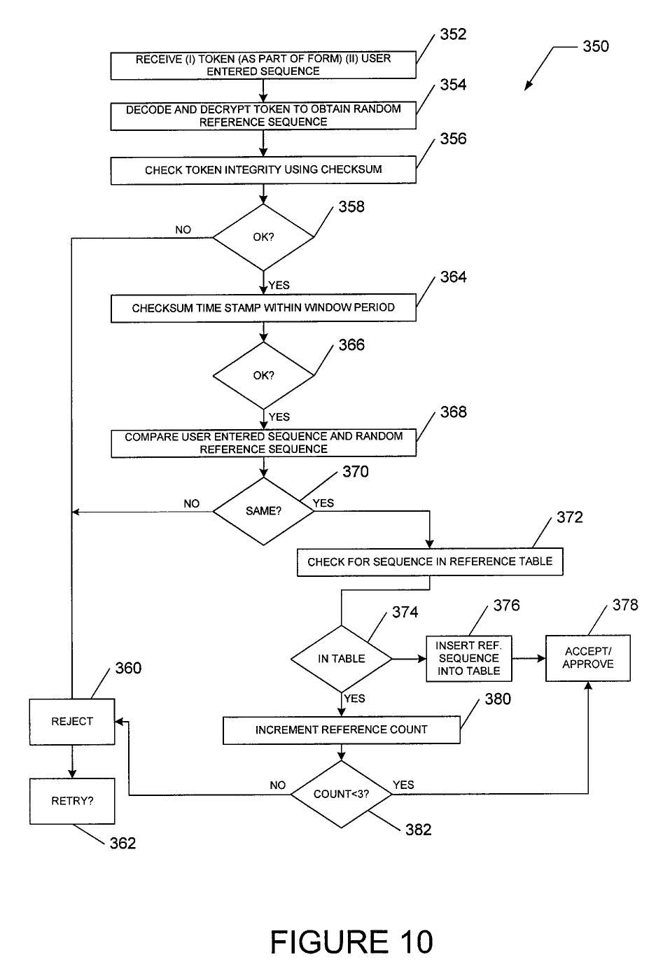

In certain circumstances, a user may inadvertently activate the “GO” button 28 more than once, for example, due to a slow refresh rate on a display screen. Thus, in certain embodiments, the reference data may be valid for more than one perceived transaction attempt. In these circumstances, if the user entered sequence and the reference sequence match, a further check is conducted to determine if the same token has already been used as a basis for a transaction validation (see operation 372). In particular, the method 120 accesses a table 400 (see FIG. 13) to obtain usage information on the token and its reference data. As shown at decision operation 374 in FIG. 10, if the number of the token is not included in the table 400, it is then inserted into the table 400 (see operation 376) and its reference count is set at “1” (see column 402 in FIG. 13). Thereafter, the transaction process is authenticated or effected, as shown at operation 378.

However, returning to decision operation 374, if the reference sequence associated with the token is included in the table 400, its reference count included in column 402 is incremented (see operation 380) and the method 120 then checks to see if the count associated with the token exceeds a predetermined maximum number. For example, if the predetermined maximum number is three, then once the count in the table 400 has reached three, any transaction attempt after that using the same reference number is rejected (see operation 382 and 360 in FIG. 10). If, however, the account is less than three, then the transaction process may be completed (see operation 378).

In certain embodiments, the table 400 includes an age column 404, which is used to check whether or not the time stamp is within the predetermined window period (see operation 364). A transaction attempt may be selectively rejected dependent upon the count in column 380 and the age of the token as shown in column 404. Comments 406 in FIG. 13 show an exemplary application of the methodology described above in which the time window is 120 minutes and the maximum number of retry attempts using the same reference data is three.

In the embodiments described above, the servers 30, 32 and 58 are shown as separate servers, which may be located at different facilities. Thus, in one embodiment, the token communicated between the different servers may be the only interaction between the servers 30, 32 and 58. In this embodiment, a single centralized table 400 may be provided on the server 30 and it need not be replicated on the servers 32 and 58. However, it will be appreciated that in other embodiments, any two or more of the servers may be combined into a single server.

### User Interfaces

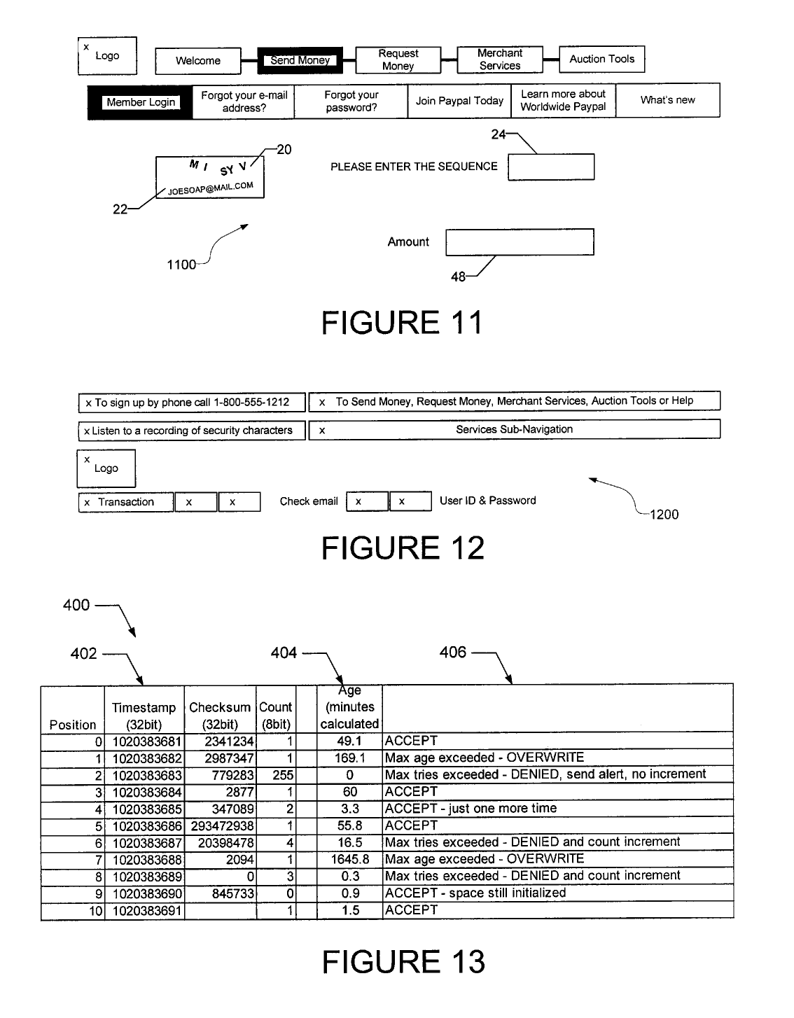

An exemplary screen shot of an embodiment of a user interface 1100 served by the application server 58 to the browser application 16 is shown in FIG. 11. The user interface 1100 of FIG. 11 is typically generated using HTML and, as mentioned above, although one of the example embodiments describe the system with reference to a transaction process, it may be used to monitor user interaction with the computer 12 in any other circumstances. As the image 22 is modified in such a fashion that it inhibits identification of the reference sequence by a robot or any other automated process, the resultant image 22 may be difficult for a visually impaired person to read. Accordingly, as shown in an example user interface 1200 of FIG. 12, an alternative sign up or transaction procedure may be provided in which a toll free number 1-800-555-1212 is provided for a visually impaired person to call and thereby to effect transaction. Another alternative sign up or transaction procedure may be provided where a visually impaired person is provided with the option to listen to a recording of “security characters” such as the reference sequence.

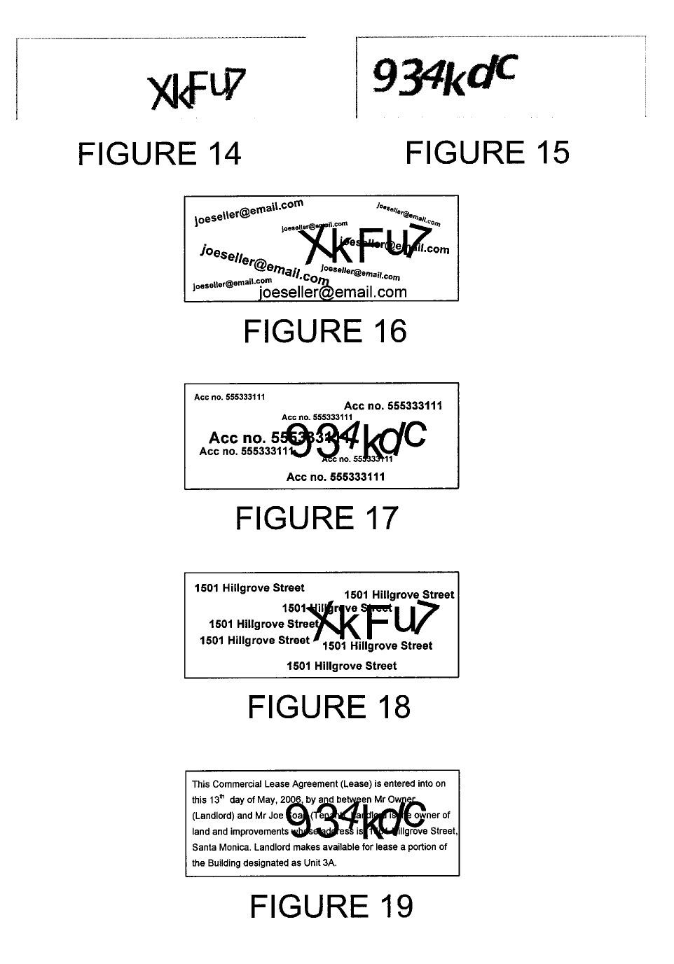

FIGS. 14 and 15 show two example embodiments of visual challenges generated according to the method of FIG. 5. FIG. 14 shows a reference sequence “XkFu7”, comprising characters and numbers as glyphs which have been modified and distorted as described above thereby to form a visual challenge. Similarly FIG. 15 shows a visual challenge comprising a reference sequence “934 kdc”.

FIGS. 16 to 19 show various example embodiments of transactional visual challenge images generated according to the example embodiment methods of FIGS. 4 to 7. FIG. 16 shows a visual challenge comprising a reference sequence “XkFu7” and a transactional background which comprises various sizes of the e-mail address of a recipient of a financial transaction. The e-mail address appears in different locations, sizes and orientations in the predefined image area. Similarly, FIG. 17 shows a transactional visual challenge image with the visual challenge comprising a reference sequence “934 kdc” and where the transaction identifier forming the transactional background is an account number presented in varying sizes. FIG. 18 shows a transactional visual challenge image with the transaction identifier being a shipping address. In turn, FIG. 19 shows a visual challenge formed by reference sequence “934 kdc” having a transactional background that is a portion of a lease contract.

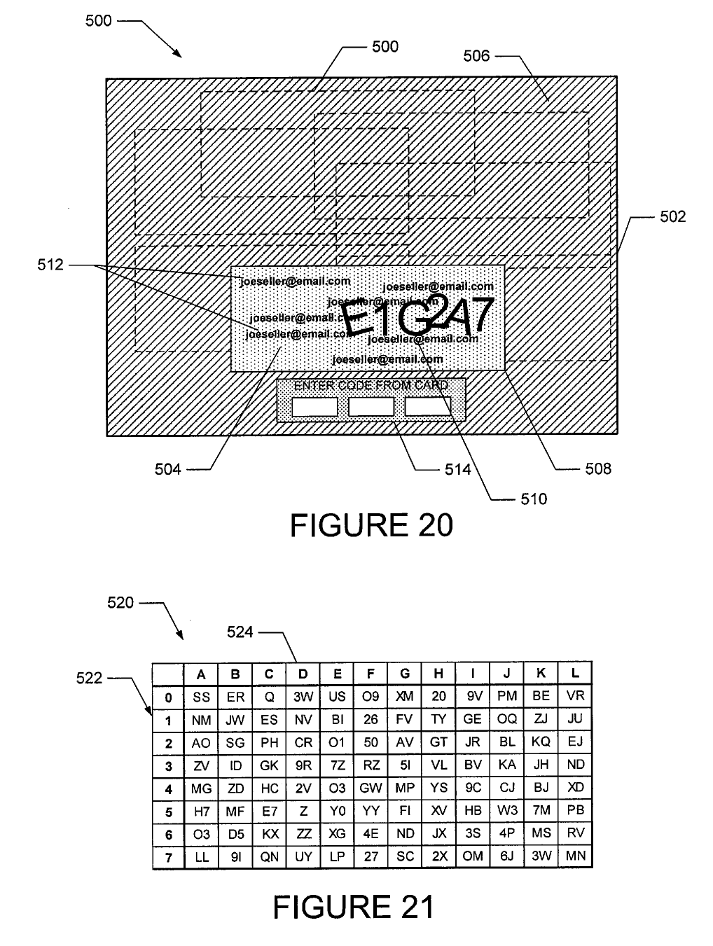

FIG. 20 shows an example embodiment of an image 500 generated using the methods of FIGS. 4 to 8. The image 500 comprises shared secret data in the form of a secret visual image 502. The secret visual image 502 may comprise a portion of fully revealed secret visual image 504 and a portion of partially revealed secret visual image 506. In an example embodiment, the portion of fully revealed secret visual image 504 may be a colored portion of a bigger image. The portion of fully revealed secret visual image overlays a transactional visual challenge image 508 formed by a challenge image 510 (reference sequence “E1 G2A7”) and a transactional background formed by various presentations of an e-mail address of a recipient of a transaction (transaction identifiers 512).

In an example embodiment, this image 500 is presented to a user during transaction authentication with the user being prompted to solve the visual challenge. During the process of solving the visual challenge, the user identifies the reference sequence forming the visual challenge, but also checks whether the transactional visual challenge image is overlayed with an incremental fully revealed portion of the secret visual image.

In one example embodiment, the user may make use of a grid card 520 as shown by FIG. 21 to enter the identified reference sequence. The grid card 520 comprises rows 522 and columns 524 which provide keys associated with the challenge image of the transactional visual challenge image. The visual cards may be issued by a transaction provider to all users of the system shown in FIG. 1. For example, the visual cards may be e-mailed or mailed to a user on registering with the system of FIG. 1. In addition to carrying a grid card key, the grid card may, on its back side, carry temporary secret visual images that may be used as a shared secret by the transaction provider whenever a user wants to execute a transaction. By using the grid card 520 to solve the visual challenge shown in FIG. 20, a user would enter “US” for the first two glyphs of the reference sequence (i.e. “E1”), “AV” for the next two glyphs (i.e. “G2”) and “LL” for the last two glyphs (i.e. “6A7”).

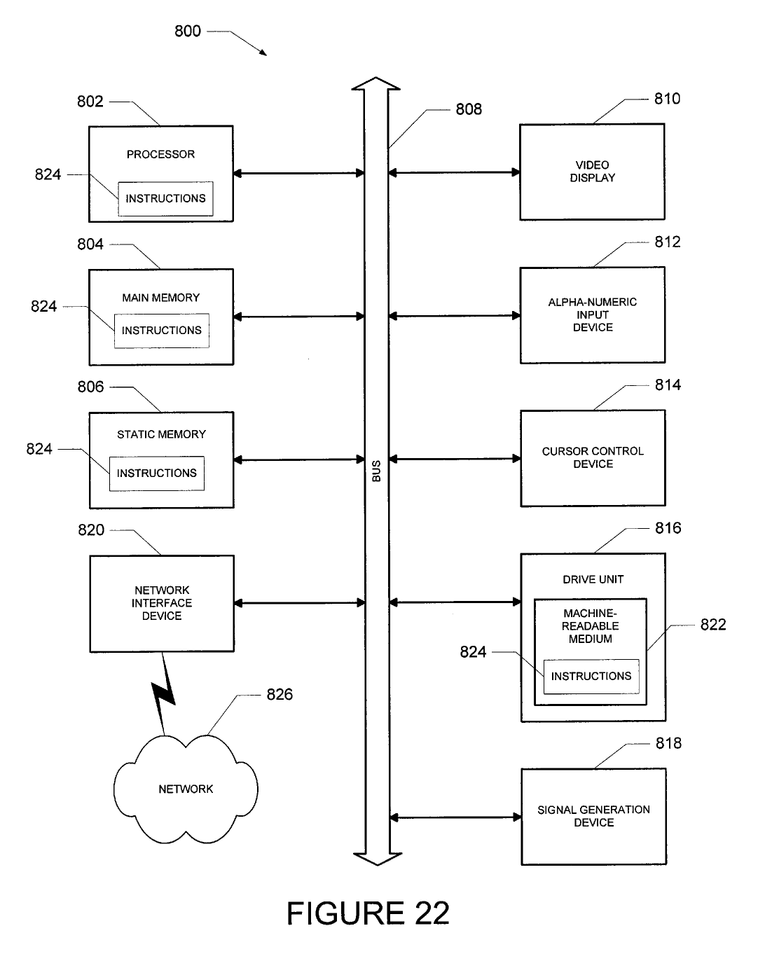

FIG. 22 shows a diagrammatic representation of machine in the example form of a computer system 800 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU) a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions (e.g., software 824) embodying any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to generate a transactional visual challenge image to be presented to a user to verify that the user is human have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a challenge image module to generate a visual challenge to be presented to a user as part of a challenge-response to verify that the user is human;
a transactional background image module to identify a transactional background that is associated with a particular transaction to which the user is a party; and
a combiner image module to combine the visual challenge and the transactional background into an image which is to be presented to the user, the transactional background associating the visual challenge with the particular transaction.

2. The system of claim 1, wherein the visual challenge is an image-based test to which the response is provided by the user.

3. The system of claim 2, wherein the transactional background is associated with the particular transaction from the perspective of a transaction server/processor.

4. The system of claim 3, wherein the particular transaction is a financial transaction, an agreement or a contract.

5. The system of claim 4, wherein the financial transaction relates to a purchase transaction, a barter transaction or a transfer of money from a bank or monetary account.

6. The system of claim 5, wherein the transactional background includes a transaction identifier associated with the particular transaction.

7. The system of claim 6, wherein the transaction identifier is at least one of a group of identifiers consisting of an identifier of a payment recipient, a transaction amount, a shipping address and a portion of a contract or agreement.

8. The system of claim 7, wherein the identifier of the payment recipient is an e-mail address, an account identifier or a personal identification number.

9. The system of claim 8, wherein the transactional background is a watermark to the visual challenge.

10. The system of claim 1, wherein the challenge image module is to generate a visual challenge by modifying a plurality of randomly selected glyphs by randomizing at least one of a spacing, placement, font type, font size, glyph orientation or vertical offset of each of the glyphs.

11. The system of claim 1, wherein the transactional background image module is to:
select the transaction identifier; and
select a number of times the transaction identifier is to be presented on a predefined image area.

12. The system of claim 11, wherein the transaction background image module is to:
select a random size for a presentation of the transaction identifier;
select a random location for the presentation of the transaction identifier;
select a random orientation for the presentation of the transaction identifier; and
distribute the presentation of the transaction identifier in the predefined image area.

13. The system of claim 12, wherein the transactional background image module is to determine the location of the visual challenge in the predefined image area prior to selecting a random location for the presentation of the transaction identifier.

14. A method comprising:
generating a visual challenge to be presented to a user as part of a challenge-response to verify that the user is human;
identifying a transactional background that is associated with a particular transaction to which the user is a party; and
combining the visual challenge and the transactional background into an image which is to be presented to the user, the transactional background associating the visual challenge with the particular transaction.

15. The method of claim 14, wherein the visual challenge is an image-based test to which the response is provided by the user.

16. The method of claim 15, wherein the transactional background is associated with the particular transaction from the perspective of a transaction processor/server.

17. The method of claim 16, wherein the particular transaction is a financial transaction, an agreement or a contract.

18. The method of claim 17, wherein the financial transaction relates to a purchase transaction, a barter transaction, or a transfer of money from a bank or monetary account.

19. The method of claim 18, wherein the transactional background includes a transaction identifier associated with the particular transaction.

20. The method of claim 19, wherein the transaction identifier is at least one of a group of identifiers consisting of an identifier of a payment recipient, a transaction amount or a shipping address and a portion of a contract or agreement.

21. The method of claim 20, wherein the transaction identifier of the payment recipient is an e-mail address, an account identifier or a personal identification number.

22. The method of claim 21, wherein the transactional background is a watermark to the visual challenge.

23. The method of claim 14, wherein generating a visual challenge includes modifying a plurality of randomly selected glyphs by randomizing at least one of a spacing, placement, font type, font size, glyph orientation or vertical offset of each of the glyphs.

24. The method of claim 23, wherein identifying a transactional background includes automatically generating a transactional background.

25. The method of claim 19, wherein identifying a transactional background includes:
selecting the transaction identifier and a number of times the transaction identifier is to be presented on a predefined image area.

26. The method of claim 25, wherein identifying a transactional background includes:
selecting a random size for a presentation of the transaction identifier;
selecting a random location for the presentation of the transaction identifier;
selecting a random orientation for the presentation of the transaction identifier; and
distributing the presentation of the transaction identifier in the predefined image area.

27. The method of claim 26, wherein selecting a random location for the presentation of the transaction identifier includes determining the location of the visual challenge in the predefined image area.

28. A system comprising:
means for generating a visual challenge to be presented to a user as part of a challenge-response to verify that the user is human;
means for identifying a transactional background that is associated with a particular transaction to which the user is a party; and
means for combining the visual challenge and the transactional background into an image which is to be presented to the user, the transactional background associating the visual challenge with the particular transaction.

29. A machine-readable medium embodying a set of instructions to perform the method of claim 14.
